(19) United States
(12) Patent Application Publication
(10) Pub. No.: US 2006/0132544 A1
(43) Pub. Date: Jun. 22, 2006

(54) Laser tacking and singulating method and system

(76) Inventors: Richard E. Corley JR., Richmond, KY (US); Neal D. Erickson, Lexington, KY (US); Paul T. Spivey, Lexington, KY (US); Carl E. Sullivan, Stamping Ground, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/017,994

(22) Filed: Dec. 21, 2004

(51) Int. Cl. B41J 2/14

(52) U.S. Cl. 347/50

(57) ABSTRACT

A method, and an apparatus employing the method, of using a laser to secure a composite film to a substrate. The method includes the acts of positioning the composite film adjacent the substrate, and heating at least a portion of the composite film with the laser and thereby tack the composite film to the substrate.

### BACKGROUND

1. FIELD OF THE INVENTION

Embodiments of the invention relate generally to the use of lasers to secure component to an integrated circuit chip. More specifically, embodiments of the invention relate to a method and system to secure a nozzle array to a substrate using a laser.

2. DESCRIPTION OF THE RELATED ART

A thermal inkjet print head generally includes a series of ejection devices that are generated by joining a heater chip and a nozzle member. When energized, the heater chip fires a droplet of ink. The nozzle member focuses the energy and direction of the droplet such that the ink droplet can be precisely located.

Many methods are used to align and attach the nozzle member to the heater chip. For example, orifices of the nozzle member are first visually aligned with orifices on the heater chip. Thereafter, an ultra-violet (“UV”) curable adhesive is used to tack the nozzle member in place. A function of the UV curable adhesive is to hold the nozzle member in a correct alignment with the heater chip until the nozzle member can be permanently affixed to the heater chip. Typically, the nozzle member can be permanently affixed or bonded to the heater chip by heat and pressure. More particularly, a typical nozzle member can have a layer of adhesive thereon. The adhesive layer of the nozzle member can ultimately provide a bond between the nozzle member and the heater chip. In some other cases, the adhesive layer can be placed on the heater chip that will then be bonded to the nozzle member when heated and subjected to pressure.

One method of applying UV adhesive uses a pin to apply drops of the UV adhesive to the heater chip prior to aligning the nozzle member with the heater chip. The UV adhesive drops may be placed in one or more corners or edges of the heater chip such that at least a portion of the UV adhesive will be exposed after the nozzle member is placed on the heater chip. The exposed UV adhesive portion absorbs UV radiation, which initiates a cure throughout the UV adhesive that will provide the desired tack. However, pin transfer of UV adhesive generally requires that the pin be placed close to the heater chip. As a consequence, the heater chip can be damaged if the pin is not placed accurately. Furthermore, the act of pin transfer often causes defects in the heater chip when the pins contact the substrate.

If the amount of the UV curable adhesive is inaccurately controlled, excessive adhesive can also damage the heater chip. Generally, the size of UV adhesive drops is difficult to control precisely. Frequently, the UV adhesive extends beyond its desired boundaries. The UV adhesive also raises the corner or edge of the nozzle array that is placed directly above the UV adhesive. This causes the nozzle member to have a tent-like structure locally and usually leaves a small void between the nozzle array and the heater chip at the interface of the nozzle array and UV adhesive drop. Ink can then wick into the void and begin to attack any bond between the nozzle array and the heater chip or any other polymer layers attached to the heater chip such as a photo-resist layer. The ink can also begin to attack the heater chip directly in any nearby region where there are fiducials or gaps between the heater chip and other protective layers causing corrosion and failure of the heater chip. A very common mode of corrosion failure is ink ingression at the UV adhesive drops.

An inaccurate amount of UV adhesive drops can cause deformation of the nozzle array and the substrate. The deformed nozzle array and the substrate can induce inadvertent concentrated pressure to the nozzle array and the substrate during a thermal compression in which the nozzle array and the substrate are bonded permanently. In extreme cases, the pressure can cause a wafer, the substrate, or the chip to crack. The pressure can also induce other stress regions on the heater chip. Furthermore, the UV adhesives require some of the material to be exposed such that the UV adhesive can absorb UV radiation. However, additional adhesive generally requires additional fiducials or openings in the nozzle member that is larger than the heater chip attached to hold the additional UV adhesive. In some cases, adhering the nozzle array to the substrate is a time consuming process. For example, some equipment designs can take about 1.5 second-cycle times including 0.5 seconds for the UV adhesive to cure. After temporarily aligning and attaching the array of nozzles to the heat chip with the UV curable adhesive, the aligned nozzle array is transported to another location or machine to be subjected to the thermal bonding process.

### SUMMARY OF THE INVENTION

Accordingly, there is a need for an improved method for separating a nozzle array from a sheet and attaching the nozzle array in place on die.

The following summary sets forth certain embodiments of the invention described in greater detail below. It does not set forth all such embodiments and should in no way be construed as limiting of the invention.

In one form, the invention provides a method of using a laser to secure a composite film to a substrate. The method includes the acts of positioning the composite film adjacent the substrate and heating at least a portion of the composite film with the laser and thereby tack the composite film to the substrate.

In another form, the invention provides a method of using a laser to secure a nozzle array to a substrate. The method includes the act of providing an adhesive between the nozzle array and the substrate. The adhesive is adhered to a one of the nozzle array and the substrate. The method also includes the act of energizing the laser to heat at least a portion of the adhesive and thereby tack the nozzle array to the substrate.

In yet another form, the invention provides an apparatus for attaching a nozzle array to a substrate, wherein an adhesive is positioned between the nozzle and the substrate. The apparatus includes a laser galvanometer operable to generate a laser beam, and a controller coupled to the laser galvanometer. The controller is configured to activate the laser galvanometer to heat at least a portion of the adhesive and thereby tack the nozzle array to the substrate.

In yet another form, the invention provides method of securing a nozzle array to a substrate. The method includes the act of aligning the nozzle array and the substrate, wherein an adhesive adheres to a one of the nozzle array and the substrate. The method also includes the acts of exposing at least a portion of the adhesive with a first laser radiation, melting the exposed portion of the adhesive with a second laser radiation, and applying a third laser radiation to the other portion of the adhesive.

Other features and advantages of the invention will become apparent to those skilled in the art upon review of the following detailed description, claims, and drawings.

### BRIEF DESCRIPTION OF THE DRAWINGS

FIG. 1 is a block diagram of a tacking and singulating system.

FIG. 2 is a tacking and singulating apparatus with a laser galvanometer.

FIG. 3 is a flow chart of a tacking and singulating process.

FIG. 4 illustrates a sectional cut view of a film positioned on a wafer after an initial radiation.

FIG. 5 illustrates a second sectional cut view of the film positioned on the wafer after a low energy melt.

FIG. 6 illustrates a third sectional cut view of the film positioned on the wafer after a final radiation.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. In addition, the terms “connected” and “coupled” and variations thereof are not restricted to physical or mechanical connections or couplings.

Embodiments of the invention relate to a method of using a laser beam to both separate a nozzle array from a sheet or a web and attach it in place on a die or substrate. Particularly, embodiments of the invention relate to a method of tacking a nozzle array to the heater chip without introducing additional material such as UV adhesive. In some cases, the introduction of heat is also desirable when accurately managed.

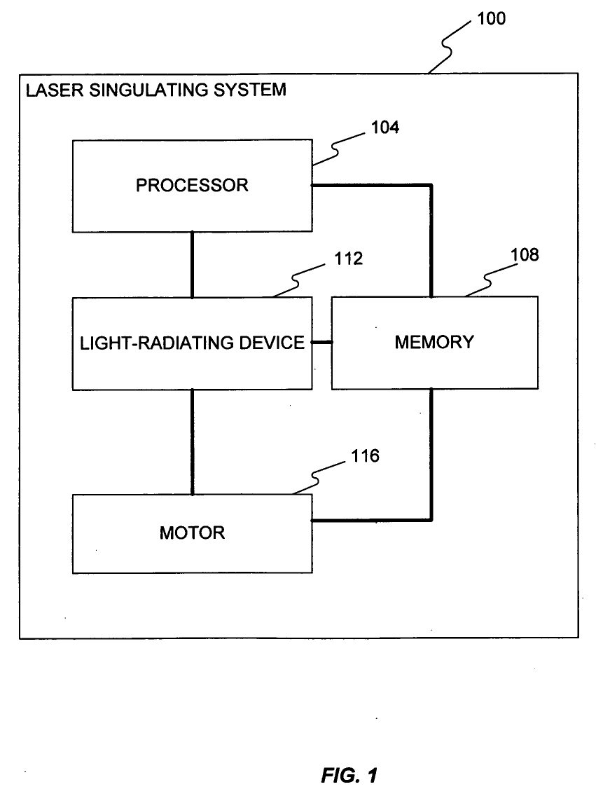

FIG. 1 illustrates an exemplary laser tacking and singulating system 100. The laser singulating system 100 includes a controller or a processor 104 that controls the other components of the laser singulating system 100. The processor 104 can be a general-purpose micro-controller, a general-purpose microprocessor, a dedicated microprocessor or controller, a signal processor, an application-specific-integrated circuit (“ASIC”), and the like. The processor 104 executes instructions from a program stored in a memory 108. Although the memory 108 is shown as being external to the processor 104, the memory 108 can also be internal to the processor 104. The laser singulating system 100 also includes a light-radiating element 112 such as a laser or a laser galvanometer and a plurality of motors collectively represented as a motor 116. The light-radiating element 112, when activated by the processor 104, can generate a laser beam at a plurality of energy levels, detailed hereinafter. The motor 116 generally moves a plurality of components of the system 100, which are detailed hereinafter.

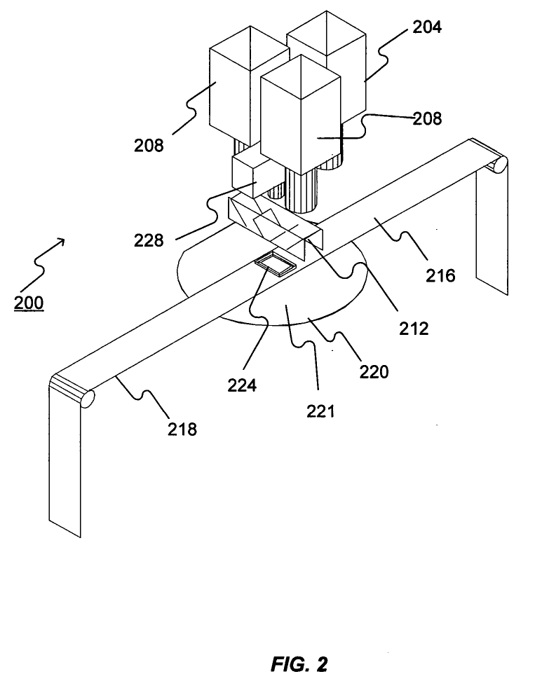

FIG. 2 shows an exemplary singulating apparatus 200 that includes a plurality of cameras. For example, the cameras can include a low magnification camera 204, and high magnification cameras 208. In the embodiment shown, the apparatus 200 also includes an optics block 212 to improve the focus of the cameras 204, 208 on a film 216 of nozzle arrays. In the embodiments shown, the film 216 has a bottom side 218 that is coated with adhesive. A wafer 200 is positioned below the film 216. The wafer has a top side 221 which may alternatively be coated with an adhesive. The apparatus 200 also includes a frame 224 such that when the frame 224 is lowered, the film 216 is brought or pressed into contact with the wafer 220. The motor 116 (of FIG. 1) moves the film 216 into position for radiation by laser beams generated by a light-radiating device 228 such as a laser or a laser galvanometer.

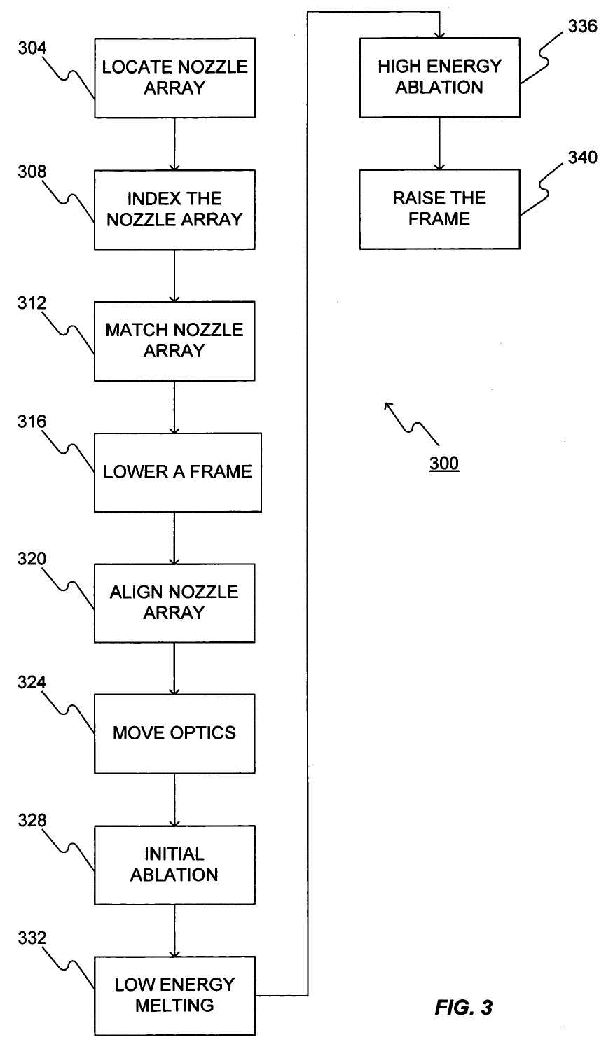

FIG. 3 includes a flow chart that further illustrates a tacking and singulating process 300. The process 300 may be carried out by software, firmware, or hardware. The process 300 starts with locating a nozzle array on the film 216 (of FIG. 2) with the low magnification camera 204 at block 304, such that the nozzle array can be approximately located. Once the nozzle array has been located, the film 216 is indexed at block 308. The processor 104 (of FIG. 1) through the motor 116 and the cameras 204, 208 aligns a plurality of fiducials or orifices of the nozzle array to match a plurality of theoretical positions of the fiducials on the wafer 220 below, also at block 312.

When the nozzle array of the film 216 is aligned with the substrate or the wafer 220 below, the frame 224 is lowered to bring the nozzle array into contact with the substrate 220 at block 316. Thereafter, the nozzle array on the film 216 and the substrate 220 are aligned (as controlled by the processor 104) with the high magnification camera 208, the optics block 212, and the motoring unit 116, at block 320. Once aligned, the optics block 212 is moved away from light-radiating device 228, at block 324.

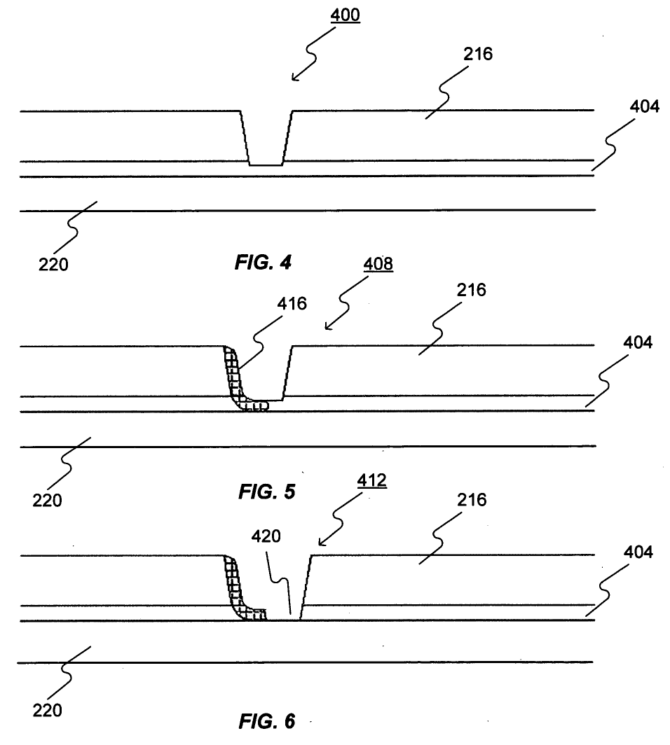

The nozzle array and the substrate are subjected to a plurality of laser ablations with different energy levels. In general, a laser beam with a first energy level initially drills down into the adhesive layer that touches a surface of the substrate. In this way, the adhesive is exposed between the nozzle array and the substrate after block 328. FIG. 4 shows a sectional cut 400 of a resulting film 216 showing that an adhesive layer 404 of the film 216 is exposed after the initial ablation.

Continuing with the description of the process 300, a much lower energy beam is applied to heat the exposed adhesive layer 404 to melt the exposed adhesive layer 404 into the surface of the substrate 220, at block 332. FIG. 5 shows a sectional cut 408 of a resulting film 216 showing that the melted adhesive has penetrated into the substrate 220. In some embodiments, the laser can be transparent to the nozzle array and can be absorbed by either the adhesive layer 404 or, more specifically, a plurality of features on the heater chip on the substrate 220. These features can act as targets that can provide heat in specific areas of interest in tacking. These features can withstand a plurality of heating cycles without being degraded. In some embodiments, the feature can be a patch of bare silicon that is extremely heat resistant, or a plurality of ejector heater metals that also have been proven to withstand extreme heat cycles. In some cases, providing heat in specific areas of interest can be achieved with a mask that only exposes certain regions to a laser radiation. A waveguide can also be used both to direct the laser radiation to the specific areas of interest and to provide the pressure necessary to complete the tacking process. In some other embodiments, a blanket layer of radiation that only energizes specific target regions can also be used. By having or concentrating in specific heated regions, the heater chip or other circuitry on the heater chip is subjected to less fatigue. Further, the laser can be controlled precisely by the processor 104 and the light-radiating device 228 such as the laser galvanometer to provide desired amounts of heat.

Another improvement realized by using a heat source such as a laser is rapid heating. When using such a heat source, heating can be removed and cooling can be achieved rapidly as silicon is an excellent conductor of heat. In this way, the nozzle array adhesive is allow to tack to the heater chip, which can then be ready for thermal compression bonding in which a permanent bond between the heater chip and the nozzle array is created.

A final ablation at high energy level is then applied to remove the residue of the adhesive thereby connecting the nozzle array and its surrounding material at block 336 (of FIG. 3). FIG. 6 shows a sectional cut 412 of the resulting film 216 showing that the residual adhesive is gone, and that the substrate 220 is now exposed. In general, the low energy laser beams and the high-energy ablations work in different portions of the nozzle array and the substrate 220; otherwise, the adhesive can be vaporized. The melting is generally done on an inboard edge 416 of the initial ablation, and the final ablation is generally done on an outboard edge 420 of the initial ablation. Thereafter, the frame 224 is raised at block 440.

While the embodiments shown relate to a printhead manufacturing process, the laser tacking and singulating process with different energy levels can also be used in other wafer processing. For example, the laser tacking process can be used to tack composite films on the substrate. The tacking and singulating process can also be applicable in a circuit assembly formed on a sheet or film that is then rolled onto a reel. In such cases where the nozzle array can be larger than the diced heater chip, the laser tacking process can be carried out after the substrate has been singulated. In some embodiments, the tacking process can be carried out after the heater chip has been electrically connected to a tape-automated bonded (“TAB”) circuit.

Furthermore, if the heater chip is heated to a temperature that is substantially close to a temperature that will cause the nozzle array adhesive to become tacky, the heater chip will also thermally expand. Since the heater chip expands slower than the nozzle array does, thermally expanded heater chip using the laser can be acceptable because the thermal coefficients of expansion of the nozzle array is than that of the heater chip. In this way, a more extensive tack can be achieved, specifically in the area near the heater chip where a good bond is typically desired. On the other hand, heating the heater chip locally can minimize the effects of the heat on alignment of the nozzle array and the substrate, provide a quick and efficient method of heating, and put a minimum amount of stress on the heater chip.

In some embodiments, the heater chip is electrically connected to a circuit assembly on a reel. A large nozzle member can be pressed into contact with a plurality of areas of the heater chip. The heater chip can be heated quickly with the use of a laser causing the nozzle array adhesive to wet to the heater chip. The laser can then be turned off, allowing the heat to quickly dissipate and the nozzle array to be tacked to the heater chip. The circuit assembly is then ready for thermal compression bonding. Additionally, in the case of a reel of circuit assemblies and large nozzle members tacked to the heater chips, this type of heating could be used for or to aide in the thermal compression bonding process. For example, the thermal bonding process can be enhanced by proving some or all of the heat necessary for a permanent bond just prior to curing the nozzle array adhesive.

Various features and advantages of the invention are set forth in the following claims.

1. A method of using a laser to secure a composite film to a substrate, the method comprising the acts of:
positioning the composite film adjacent the substrate; and
heating at least a portion of the composite film with the laser and thereby tack the composite film to the substrate.

2. A method as set forth in claim 1, and wherein the composite film includes an adhesive configured to adhere the composite film to substrate, the method further comprising the act of exposing the adhesive layer with the laser energized at a first energy level, and wherein the act of heating at least a portion of the composite film further comprises energizing the laser at a second energy level different from the first energy level.

3. The method as set forth in claim 2, further comprising the act of energizing the laser at a third energy level to singulate the composite film and substrate from a web.

4. The method as set forth in claim 2, further comprising the act of pressing the composite film into contact with the substrate.

5. A method as set forth in claim 1, further comprising the act of positioning at least one of a silicon substrate and a plurality of ejector heater metals on the substrate.

6. A method as set forth in claim 1, further comprising the act of masking a portion of the composite film adhered to the substrate.

7. A method as set forth in claim 1, further comprising the act of directing the laser with a waveguide.

8. A method as set forth in claim 1, further comprising the act of applying pressure with a frame to the composite film and the substrate.

9. A method as set forth in claim 1, further comprising the act of energizing the laser at a target region using a blanket layer of radiation.

10. A method as set forth in claim 1, and wherein heating the portion of the composite film with the laser further comprises heating the portion of the nozzle temporarily with the laser prior to a thermal compression bonding.

11. A method as set forth in claim 1, and wherein the composite film comprises thereon at least one of a nozzle array, and a tape-automated bonded circuit.

12. A method of securing a nozzle array to a substrate with a laser, the method comprising the acts of:
providing an adhesive between the nozzle array and the substrate, the adhesive being adhered to a one of the nozzle array and the substrate; and
energizing the laser to heat at least a portion of the adhesive and thereby tack the nozzle array to the substrate.

13. A method as set forth in claim 12, further comprising the act of energizing the laser at a first energy level to expose the adhesive layer, and wherein the act of energizing the laser to heat a portion of the adhesive further comprises energizing the laser at a second energy level different from the first energy level.

14. A method as set forth in claim 13, further comprising the act of energizing the laser at a third energy level to singulate the nozzle array and substrate from a web.

15. A method as set forth in claim 13, further comprising the act of absorbing energy at the adhesive.

16. A method as set forth in claim 12, further comprising the act of positioning at least one of a silicon substrate and a plurality of ejector heater metals on the substrate.

17. A method as set forth in claim 12, further comprising the act of masking a portion of the nozzle array adhered to the substrate.

18. A method as set forth in claim 12, further comprising the act of directing the laser with a waveguide.

19. A method as set forth in claim 12, further comprising the act of applying pressure with a frame to the nozzle array and the substrate.

20. A method as set forth in claim 12, further comprising the act of energizing the laser at a target region using a blanket layer of radiation.

21. A method as set forth in claim 12, and wherein energizing the laser further comprises energizing the laser temporarily prior to a thermal compression bonding.

22. A method as set forth in claim 12,, further comprising aligning the nozzle array and the substrate.

23. An apparatus for attaching a nozzle array to a substrate, wherein an adhesive is positioned between the nozzle array and the substrate, the apparatus comprising:
a laser operable to generate a laser beam; and
a controller coupled to the laser, and configured to activate the laser to heat at least a portion of the adhesive and thereby tack the nozzle array to the substrate.

24. An apparatus as set forth in claim 23, and wherein the laser is further configured to generate a first laser beam at a first energy level to expose the adhesive, and a second laser beam at a second level different from the first energy level to melt the adhesive into a surface of the substrate.

25. An apparatus as set forth in claim 24, and wherein the laser is further configured to generate a third laser beam at a third level different from the first and the second energy level to singulate the nozzle array and substrate from a web.

26. An apparatus as set forth in claim 23, and wherein the substrate comprises at least one of a silicon substrate and a plurality of ejector heater metals positioned thereon.

27. An apparatus as set forth in claim 23, further comprising a mask configured to mask a portion of the nozzle array adhered to the substrate.

28. An apparatus as set forth in claim 23, further comprising a waveguide configured to direct the laser.

29. An apparatus as set forth in claim 23, further comprising a frame configured to apply pressure to the nozzle array and the substrate.

30. An apparatus as set forth in claim 23, and wherein the controller is further configured to activate the laser to generate blanket layer of radiation directed at a target region.

31. An apparatus as set forth in claim 23, and wherein the controller is further configured to energize the laser temporarily prior to a thermal compression bonding.

32. An apparatus as set forth in claim 23, further comprising a galvanometer configured to deflect the laser.

33. An apparatus as set forth in claim 23, further comprising a frame configured to bring the nozzle array into contact with the substrate, wherein the adhesive between the nozzle array and the substrate adheres the nozzle array to the substrate.

34. An apparatus as set forth in claim 23, further comprising a plurality of cameras configured to focus on aligning the nozzle array and the substrate.

35. A method of securing a nozzle array to a substrate, the method comprising the acts of:
aligning the nozzle array and the substrate, wherein an adhesive adheres to a one of the nozzle array and the substrate;
exposing at least a portion of the adhesive with a first laser radiation; and
melting the exposed portion of the adhesive with a second laser radiation.

36. A method as set forth in claim 35, and wherein the first laser radiation comprises a first energy level, the second laser radiation comprises a second energy level, and wherein the first energy level is different from the second energy level.

37. A method as set forth in claim 35, further comprising applying a third laser radiation to the other portion of the adhesive.

38. A method as set forth in claim 37, and wherein the third laser radiation comprises a high-energy ablation.

39. A method as set forth in claim 35, further comprising electrically connecting the substrate to a circuit on a reel.

40. A method as set forth in claim 35, further comprising pressing the nozzle array into contact with the substrate.
